(19) United States
(12) Patent Application Publication
(10) Pub. No.: US 2010/0116858 A1
(43) Pub. Date: May 13, 2010

(54) HOCKEY STICKS TRANSPORT CARRIER FOR A VEHICLE

(76) Inventor: Jeffery T. Foley, Macomb Township, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 12/608,073

(22) Filed: Oct. 29, 2009

Related U.S. Application Data
(60) Provisional application No. 61/198,814, filed on Nov. 10, 2008.

(51) Int. Cl. B60R 9/055; B60R 9/08

(52) U.S. Cl. 224/315; 224/319; 224/317; 224/328

(57) ABSTRACT

A carrier for elongated equipment for sports, such as hockey or the like is arranged to be mounted on a roof transport rack of an automotive vehicle. The carrier is molded from a high impact plastic material and consists of an elongated straight portion integrally attached to an angular offset portion defining an elbow between the two portions. The carrier is mounted to the roof transport rack with the angular offset end facing the rear of the vehicle such that a cover door mounted to the carrier can be pivoted downward to gain access to the interior space of the carrier and hockey sticks may conveniently be loaded into the carrier, handle end first, whereafter the cover member is pivoted to a closed and locked position to contain the hockey sticks within the interior space of the carrier during transporting thus avoiding interference with passengers in the interior portion of the vehicle.

### CROSS-REFERENCE TO RELATED APPLICATION

This application claims priority to U.S. Provisional Patent Application Ser. No. 61/198,814 filed on Nov. 10, 2008.

### FEDERALLY SPONSORED RESEARCH OR DEVELOPMENT

Not applicable.

### REFERENCE TO SEQUENCE LISTING

Not applicable.

### BACKGROUND OF THE INVENTION

1. Field of the Invention

The invention relates to carriers for personal, elongated equipment for sports used in conjunction with an equipment rack for mounting atop vehicles including sport utility vehicles (SUV), minivans, and the like for carrying sports equipment during their transport and more particularly, to a carrier configured to enclose one or more hockey sticks for improved user accessibility and to facilitate loading, unloading, and transporting such equipment.

2. Description of Related Art

The prior art has recognized that dealing with hockey equipment is cumbersome, bulky, and difficult to transport. Typically, the equipment, apart from the sticks, will be carried in large nylon or canvas carry-bags. The sticks will be carried separately but dealing with sticks also presents problems. Typically, the player must negotiate doors, stairs, hallways, car entry and exit, etc. Little regard is given to this problem and when transporting sticks in a vehicle, they are left lying around in the backend of an SUV or van and as such they present a hazard to the occupants of the van or SUV. They are also subject to damage as a result of occupants of the vehicle moving about within the vehicle. Loose hockey sticks in a vehicle can also be a safety hazard in that they could become projectiles in case of a sudden stop or in the occurrence of an accident. Clearly, because of the size and shape of the equipment, a hockey stick is most effectively carried outside of the vehicle.

The prior art has failed to recognize this problem because every hockey stick carrier found during the course of the search is for personal hockey stick hand carrying. For example, Lamadelein, U.S. Pat. No. 5,249,723, discloses a rigid clip having two or more channels for grasping elongated handles of hockey sticks. Hincher, U.S. Pat. No. 5,758,767, discloses a carrier that entirely encloses the contents, has handles for grasping, and pockets to contain ancillary items. Pickel, U.S. Pat. No. 5,954,379, discloses a shafted sports equipment carrier for carrying sports equipment having a long shaft, such as a hockey stick. The carrier consists essentially of a unitary body, like Lamadelein, which has a pair of side-by-side longitudinally disposed, downwardly facing channels that are each resiliently deformable to receive and hold the shaft of a hockey stick, and an upwardly protruding inverted C-shaped handle. Finally, Cameron et al., U.S. Pat. No. 7,392,901, discloses a carrier for holding and transporting various numbers of hockey sticks and associated accessories such as pucks. None of these prior art references recognize the problems associated with having to transport hockey sticks inside a vehicle. Hickey, U.S. Pat. No. 4,109,182, discloses a hand carrier for skis. This carrier is not pertinent to hockey stick carriers except that Hickey does disclose that the hand carrier allows the skis and ski poles to be mounted on any standard car ski rack for transportation thereon.

### BRIEF SUMMARY OF THE INVENTION

This invention seeks to provide a carrier for elongated objects such as hockey sticks that can be conveniently carried most effectively outside of a vehicle on roof-mounted racks, and which reliably and conveniently secures such elongated objects of different cross-sectional dimensions without adjustments. Both placement and removal is simple and straight forward.

To some extent, the manufacturers of sports utility vehicles have anticipated such need by providing many of these vehicles with generalized racks or load carriers. In basic form, the roof rack consists of a pair of spaced parallel rails or load bars, fixedly attached to the roof of the vehicle and aligned parallel to the longitudinal centerline of the roof or transverse to it. The rails are elevated at a slight distance from the roof surface, generally three to five inches. The ends of the rails have end brackets which attach to the roof by sheet metal screws or the like and hold the rails at a predetermined height. In a common configuration, the brackets for the two transverse rails are adjustably mounted in fixed linear tracks along each side edge of the roof, providing the user with the capability of setting the spacing between the two rails.

The invention seeks to provide a carrier that is lightweight and durable, and can be fabricated by high speed injection molding techniques, thereby reducing the cost of manufacturing.

The invention provides a carrier adapted to retain a plurality of elongated shaft members, such as hockey sticks, that is intended to be permanently mounted to any vehicle roof rack. The carrier is made from a high density polyethylene material in the general shape of a hockey stick, that is, an elongated rectangular molded box-shape configuration with an angular offset at one end thereof. The carrier is mounted on the vehicle rack with the offset end facing the rear of the vehicle. Two universal metal mounting brackets are fixed to the bottom side of the carrier to install the carrier on the vehicle rack. The offset end has a hinged access panel which is lockable with a toggle latch and loop lock to receive a padlock so as to enable securing the hockey sticks within the carrier. To access the hockey sticks, the padlock is removed and toggle latch is opened to release the loop lock. The hinged access panel is pivoted downward to allow access to the hockey sticks stored within the carrier. The offset end is of sufficient size to receive and store a goalie stick which is significantly larger than a forward's or defenseman's hockey stick. The preferred embodiment of the invention can easily accommodate at least two hockey sticks. With the carrier mounted to the roof rack of the vehicle and hockey sticks secured therein, significantly more free open space is made available inside the vehicle to its occupants and will result in eliminating the safety hazard presented by carrying hockey sticks within a SUV or minivan vehicle.

Accordingly, it is a principal object of the invention to provide a carrier for enclosing, carrying, and transporting one or more hockey sticks.

It is a further object of the invention to provide a carrier that can be mounted to a standard roof rack of a sport utility vehicle or minivan which provides easy loading and unloading of hockey sticks so as to be able to transport the hockey stick on the roof of such vehicles.

Another object of the present invention is to provide a carrier for hockey sticks mounted to a vehicle roof rack that may be easily moved from one vehicle to another.

A further object of the present invention is to provide a carrier for hockey sticks which is designed to securely hold and retain the hockey sticks.

A further object of the present invention is to provide a carrier for hockey sticks which is inexpensive, dependable, and fully effective in accomplishing its intended purpose.

These and other objects of the present invention will become readily apparent upon further review of the following specification and drawings.

### BRIEF DESCRIPTION OF THE SEVERAL VIEWS OF THE DRAWINGS

FIG. 1 is a perspective view of the invention mounted on a roof-mounted rack atop a sports utility vehicle;

FIG. 2 is a perspective view of the present invention of a hockey stick carrier with mounting brackets;

FIG. 3 is an exploded view of the one end of the hockey stick carrier shown in circle A of FIG. 2, highlighting the detail of the hinged cover, cam clip, and loop lock;

FIG. 4 is an exploded view of the cam clip and loop lock which is adapted to receive a padlock to secure the hockey sticks within the carrier during transport; and

FIG. 5 is an alternative roof rack mount upon which the carrier may be mounted atop of any vehicle.

### DETAILED DESCRIPTION OF THE PREFERRED EMBODIMENT

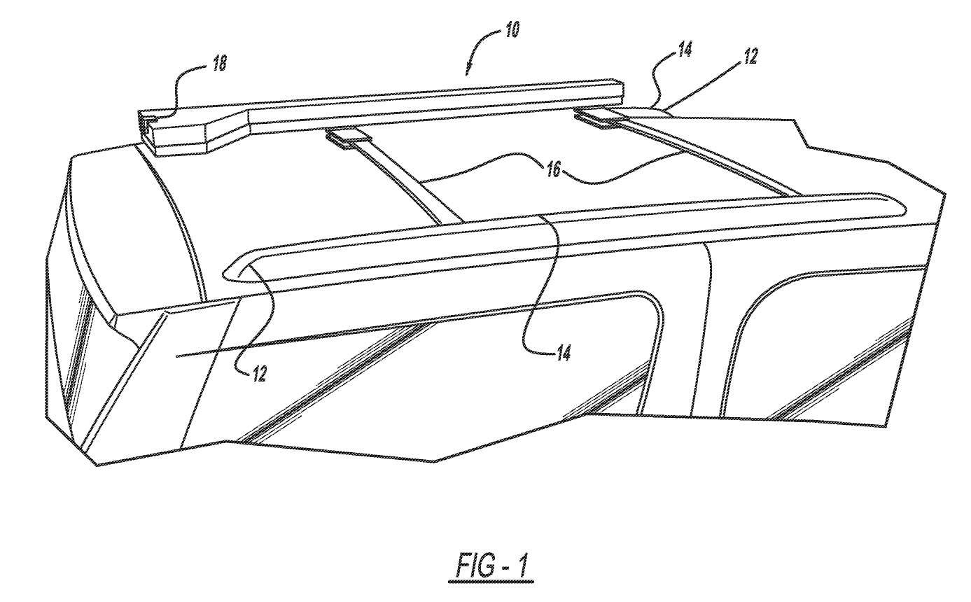

FIG. 1 illustrates the invention installed on a typical roof rack of a sports utility vehicle. This invention seeks to provide a carrier for elongated objects such as hockey sticks that can be conveniently carried most effectively outside of a vehicle on roof-mounted racks, and which reliably and conveniently secures such elongated objects of different cross-sectional dimensions without adjustments. Both placement and removal is simple and straight forward.

To some extent, the manufacturers of sports utility vehicles have anticipated such need by providing many of these vehicles with generalized racks or load carriers. As shown in FIG. 1, in basic form, the roof rack consists of a pair of spaced parallel longitudinal rails or load bars 14, fixedly attached to the roof of the vehicle and aligned parallel to the longitudinal centerline of the roof or transverse to it. The longitudinal rails 14 are elevated at a slight distance from the roof surface, generally three to five inches. The ends of the longitudinal rails 14 have end brackets which attach to the roof by sheet metal screws or the like and hold the longitudinal rails 14 at a predetermined height. In a common configuration, the brackets for the two transverse rails 16 are adjustably mounted in fixed linear tracks of the longitudinal rails mounted along each side edge of the roof, providing the user with the capability of setting the spacing between the two transverse rails 16.

As shown, the hockey stick carrier 10 is installed on the roof rack with the blade receiving end 18 facing the rear of the vehicle such that after the hinged access cover 20 is tilted downwards, the hockey sticks are inserted into the carrier 10, handle first. The carrier 10 is mounted to the vehicle roof rack with two universal mounting brackets 22 which are permanently attached to the hockey stick carrier as will be described hereinafter.

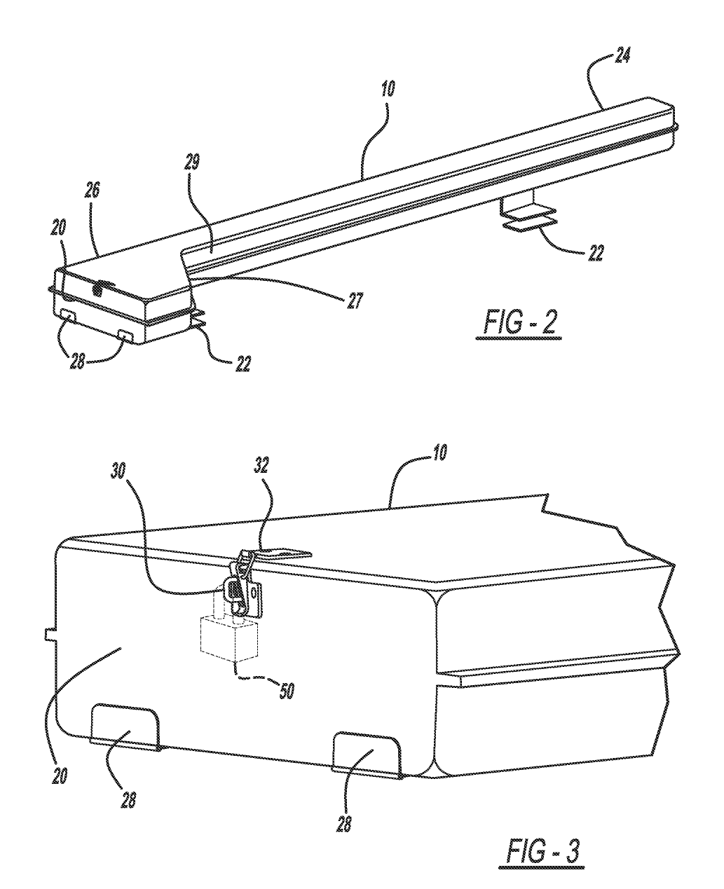

As can be clearly seen in FIG. 2, the hockey stick carrier 10 is a high density polyethylene plastic material molded into a rectangular configuration at one end 24 of approximately four by five inches to store the handle end of a hockey stick and an opposite end 26, to store the blade end of the hockey stick, which is approximately four inches high by fourteen inches wide. The overall length of the hockey stick carrier 10 is approximately eighty inches long. The stated dimensions pertain only to the preferred embodiment illustrated. A person skilled in the art will quickly recognize that the stated dimensions may vary a great deal without affecting the objects of the invention. Like a hockey stick, the transition from four inches wide to fourteen inches wide occurs near the opposite end 26 of the hockey stick carrier 10 to enable receiving the blade of the hockey stick.

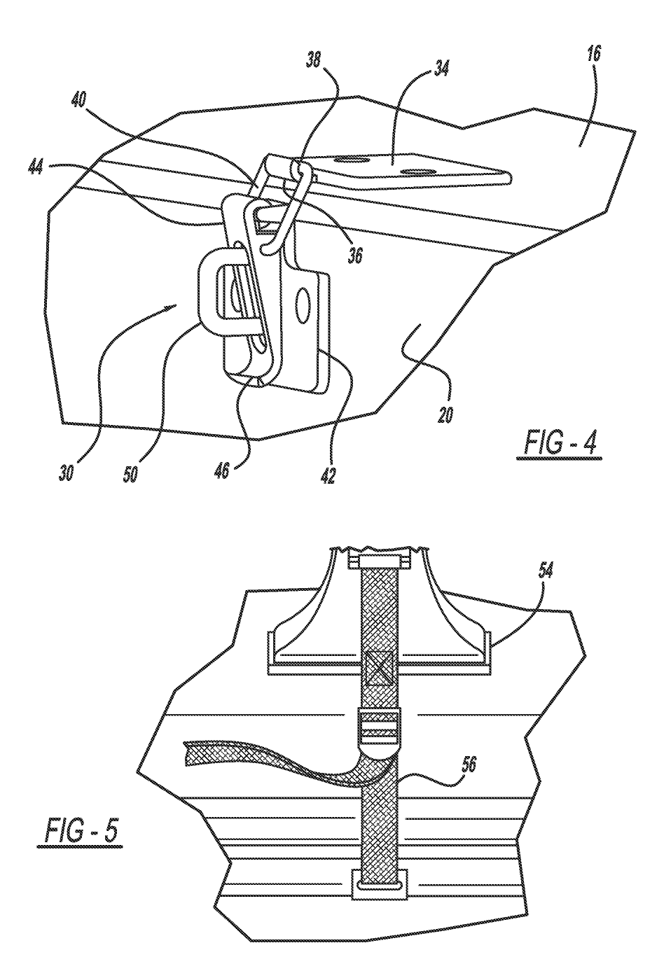

The hinged access cover 20 shown in FIG. 2 is highlighted in the exploded view of FIG. 3. Two hinges 28 are attached between the outer wall of the hockey stick carrier 10 and the hinged access cover 20 to enable pivoting the hinged access cover 20 downward so as to expose the access opening. With the hinged access cover 20 in an open position, hockey sticks can be loaded into the carrier 10, handle first, until the blade of the hockey stick slides into the widest portion of the carrier 10. After all of the hockey sticks to be transported are loaded into the carrier, the hinged access cover 20 is pivoted upwards to close the access opening and the hinged access door 20 is locked by the draw or toggle latch 30 and loop lock 32 which are illustrated in detail in FIG. 4.

The carrier lock arrangement consists of a loop plate 34 securely mounted to the top outside surface of the carrier body. The loop plate 34 has a semi-circular extended portion 36 that overhangs the hinged access cover 20 in the form of an upstanding hook edge 38 and cooperates with a latch ring loop 40 attached to the draw or toggle latch 30 so as to enable a user to lock the carrier 10 when the hockey sticks are stored therein. The lock assembly is an off the shelf item available from W.W. Grainger, Inc. The assembly consists of a toggle base plate 42 which is secured to the hinged access cover 20 in spaced relation to the loop plate 34 and semi-circular extended portion. A toggle linkage 44 mounted to the toggle base plate 42 and which, combined with the latch ring loop 40, is adapted, in an open position, to hook the latch ring loop 40 to the semi-circular extended portion 36 of the upstanding hook edge 38 of the loop plate 34 mounted to the carrier body. After the latch ring loop 40 is pivoted over the semi-circular extended portion 36 of the upstanding hook edge 38 of the loop plate 34, the toggle linkage is activated by pivoting the toggle lever 46 downwards towards the toggle base plate 42 to simultaneously lock the hinged access cover 20 and straddle a padlock ring 48 so that a padlock 50 can be attached to the padlock ring 48 and prevent anyone from opening the hinged access cover without a padlock key or combination, should the padlock be a combination padlock. The feature of being able to padlock the carrier assures no one but the owner of the hockey sticks can gain access to the sticks with an appropriate key or combination, no matter where the vehicle is parked.

The carrier 10 is mounted to the vehicle roof rack with two universal mounting brackets attached to the underside of the carrier body as illustrated in FIG. 2. One end of each bracket 22 is attached permanently to the underside of the carrier body. The opposite end of the bracket 22 has a hole at each corner to receive a mounting screw. A third bracket with mounting holes at each corner is used to trap the transverse rail 16 of the roof carrier 10 between the two brackets 22. The brackets 22 are mounted to straddle each transverse rail 16 of the vehicle. Each transverse rail 16 is straddled by two brackets 22, one above the rail 16 and one below the rail 16. Mounting screws are used to trap the transverse rail 16 between the two brackets 22 in order to securely hold the carrier on the transverse rails 16.

FIG. 5 illustrates an alternative vehicle rack which can be used for any vehicle in conjunction with the herein described invention. The roof rack as illustrated in FIG. 5 is an after-market rack that is attached to the roof of a vehicle and is attached to the drip rail and door frame of the vehicle. Each pedal 54 on opposing sides of the rack has a cooperating strap 56 that selectively attaches each pedal of the roof rack to the vehicle. After each pedal is secured using the cooperating straps at the front and rear of the roof of the vehicle, the carrier 10 of the invention is attached to a transverse rail (not shown) that extends between the pedals 54 on the left side and right side of the vehicle. The attachment of the carrier in such case is described hereinabove.

While the present invention has been described in terms of a preferred embodiment, it is apparent that other forms can be adopted by one skilled in the art. For example, the teachings of the present invention encompass any reasonable substitutions or equivalents of claim limitations. Those skilled in the art will appreciate that other applications are possible with this invention. Accordingly, the present invention is not limited to only use with sport utility models or minivans. Accordingly, the scope of the present invention is to be limited only by the following claims.

What is claimed is:

1. A carrier adapted to retain a plurality of elongated shaft members including at least one hockey stick on a roof rack of a vehicle, said carrier comprising:
an elongated body member enclosing an interior space configured to enclose and cooperate with said at least one hockey stick therein, said elongated body member having one end comprising:
a straight elongated portion adapted to receive the stick portion of a hockey stick; and
an opposite end comprising:
a short enlarged angular offset portion integrally attached to said straight elongated section adapted to receive the blade portion of a hockey stick, said short enlarged angular offset section forming an elbow in said elongated body member;
a cover member mounted to said opposite end, said cover member covering said interior space of said short enlarged angular offset section of said carrier; and
means for locking said cover member in a closed position such that said hockey sticks are secured within said interior space of said carrier;
means for mounting said carrier to said roof rack of said vehicle, said mounting means attached at one end to said elongated body member and at an opposite end secured to said roof rack of said vehicle whereby when said carrier is mounted to a roof rack of said vehicle and said plurality of hockey sticks are stored therein said plurality of hockey sticks are secure and may be transported conveniently on the roof of said vehicle.

2. The carrier as claimed in claim 1 wherein said elongated body member has two opposed planar surfaces extending along the entire length of said hockey stick carrier.

3. The carrier as claimed in claim 1, further comprising at least one hinge member having one end attached to an exterior surface of said elongated body member and an opposite end attached to said cover member whereby said cover member may be pivoted in a downward direction to allow access to said interior space of said elongated body member while said plurality of hockey sticks are loaded and unloaded from said carrier mounted on said roof rack of said vehicle.

4. The carrier as claimed in claim 1 wherein said means for locking said cover member in a closed position further comprises:
a loop plate mounted to said outside surface of said elongated body member, said loop plate having an extended portion mounted in space relation to said cover member; and
an upstanding hook edge upstanding at the terminus end of said extended portion;
a toggle base plate mounted to said cover member in space relation to said upstanding hook edge of said loop plate mounted to said outside surface of said elongated body member;
a toggle linkage fixed to said toggle base plate; and
a ring latch loop attached to said toggle linkage, said ring latch loop adapted to slide over said upstanding hook edge of said loop plate such that upon actuation of said toggle linkage by a toggle lever, said ring latch hook locks said upstanding hook edge to securely lock said ring latch hook lock to said loop plate and locking said cover member in a closed position after said plurality of hockey sticks are loaded to said carrier whereby said cover member secures said plurality of hockey sticks during transport of said at least one hockey stick in said carrier.

5. The carrier as claimed in claim 4 further comprising a padlock ring integrally attached to said toggle linkage whereby a padlock may be attached to said padlock ring and prevent access to said at least one hockey stick when loaded in said carrier.

6. The carrier as claimed in claim 1 wherein said elongated body member comprises a unitary molded plastic body.

7. The carrier as claimed in claim 6 wherein said unitary molded plastic body is made from a high density polyethylene material.

8. A hockey stick carrier for enclosing and transporting at least one hockey stick on a roof rack of a vehicle, said hockey stick carrier comprising:
an elongated body member enclosing an interior space configured to enclose and cooperate with said at least one hockey stick therein; said elongated body member having one end and an opposite end;
a cover member mounted to said opposite end of said elongated body member;
means for locking said cover member in a closed position such that said at least one hockey stick is secured within said interior space of said carrier;
means for mounting said carrier to said roof rack of said vehicle whereby when said carrier is securely mounted to said roof rack of said vehicle and said at least one hockey stick is stored within said interior space of said carrier, said at least one hockey stick may be transported conveniently by said vehicle.

9. The hockey stick carrier as claimed in claim 8 wherein said elongated body member further comprises:
one end comprising a straight elongated portion adapted to receive the stick portion of said at least one hockey stick; and
an opposite end comprising a short enlarged angular offset portion forming an elbow in said elongated body member, said short enlarged angular offset portion adapted to receive the blade portion of said at least one hockey stick.

10. The hockey stick carrier as claimed in claim 8 wherein said elongated body member has two opposed planar surfaces extending along the entire length of said hockey stick carrier.

11. The hockey stick carrier as claimed in claim 8, further comprising at least one hinge member having one end attached to an exterior surface of said elongated body member and an opposite end attached to said cover member whereby said cover member may be pivoted in a downward direction to allow access to said interior space of said elongated body member while said plurality of hockey sticks are loaded and unloaded from said carrier mounted on said roof rack of said vehicle.

12. The hockey stick carrier as claimed in claim 8 wherein said means for locking said cover member in a closed position further comprises:
a loop plate mounted to said outside surface of said elongated body member, said loop plate having an extended portion mounted in space relation to said cover member; and
an upstanding hook edge upstanding at the terminus end of said extended portion;
a toggle base plate mounted to said cover member in space relation to said upstanding hook edge of said loop plate mounted to said outside surface of said elongated body member;
a toggle linkage fixed to said toggle base plate; and
a ring latch loop attached to said toggle linkage, said ring latch loop adapted to slide over said upstanding hook edge of said loop plate such that upon actuation of said toggle linkage by a toggle lever, said ring latch hook locks said upstanding hook edge to securely lock said ring latch hoop lock to said loop plate and locking said cover member in a closed position after said plurality of hockey sticks are loaded to said carrier whereby said cover member secures said plurality of hockey sticks during transport of said at least one hockey stick in said hockey stick carrier.

13. The hockey stick carrier as claimed in claim 12 further comprising a padlock ring integrally attached to said toggle linkage whereby a padlock may be attached to said padlock ring and prevent access to said at least one hockey stick when loaded in said carrier.

14. The hockey stick carrier as claimed in claim 8 wherein said elongated body member comprises a unitary molded plastic body.

15. The hockey stick carrier as claimed in claim 14 wherein said unitary molded plastic body is made from a high density polyethylene material.
